(19) United States
(12) Patent Application Publication
(10) Pub. No.: US 2009/0139667 A1
(43) Pub. Date: Jun. 4, 2009

(54) Blind With Pockets

(76) Inventor: Claus Graichen, Henderson, NC (US)

Correspondence Address: COATS & BENNETT, PLLC, 1400 Crescent Green, Suite 300, Cary, NC, 27518, US

(21) Appl. No.: 12/119,041

(22) Filed: May 12, 2008

Related U.S. Application Data
(63) Continuation-in-part of application No. 11/948,471, filed on Nov. 30, 2007.

(51) Int. Cl. E06B 9/36

(52) U.S. Cl. 160/173 V

(57) ABSTRACT

Forming, by weaving or warp knitting, a vertical blind comprising a single fabric sheet having a series of vertical panels. The vertical panels include at least one relatively translucent panel and a plurality of vertical pocket panels. The vertical blind can be formed by weaving or knitting a fabric in width-for-width or width-for-length arrangements on a weaving loom or a double needle bar knitting machine.

This is a continuation-in-part of U.S. patent application Ser. No. 11/948,471 filed Nov. 30, 2007. The disclosure of this patent application is incorporated herein by reference.

### FIELD OF THE INVENTION

The present invention relates to vertical blinds for use in window treatments.

### BACKGROUND

Vertical blinds typically comprise a series of elongated panels suspended vertically from a support assembly. The support assembly generally includes a frame or track within which hangers are disposed. The panels are suspended by attaching panels to hangers. The hangers are typically operable to both rotate the panels about the long axes thereof and to translate the panels along the frame or track. When the panels are rotated to one extreme, the panels generally align with line of sight such that the blinds are open and allow light to pass through. When the panels are rotated to an opposite extreme, the panels generally extend normal to the line of sight and slightly overlap one another such that the blind is closed.

Such vertical blinds can be rather plain in appearance and have limited capability to provide soft effects in controlling visibility therethrough. The use of cloth drapery-like structures in association with blinds have provided improvements in appearance and softening of light control. However, the support of such drapery-like structures is sometimes problematic and operability of the window treatment provided is often cumbersome.

### SUMMARY OF THE INVENTION

A method or process for manufacturing a vertical blind is disclosed. The method or process includes weaving or knitting a single fabric sheet on a loom or knitting machine and forming within the single fabric sheet a series of elongated panels such that as the single fabric sheet is woven or knitted, the single fabric sheet moves in a direction away from the loom and the elongated panels are oriented in the same direction and extend in the general direction of movement of the single fabric sheet as the single fabric sheet moves with respect to the loom or the knitting machine.

In one embodiment, the method entails weaving a single fabric sheet on a loom where the single fabric sheet includes a pair of sides, a top portion disposed adjacent the loom, and a bottom edge disposed opposite the top portion. The method includes weaving the single fabric sheet such that as the pockets are woven, the pockets extend generally parallel to the side edges of the single fabric sheet and extend from the top portion of the single fabric sheet towards the bottom edge thereof.

In another embodiment of the invention, the method includes manufacturing a vertical blind by weaving or knitting wherein the pockets extend transversely across the single fabric sheet during the knitting or weaving operation.

Other objects and advantages of the present invention will become apparent and obvious from a study of the following description and the accompanying drawings which are merely illustrative of such invention.

### BRIEF DESCRIPTION OF THE DRAWINGS

FIG. 1 is front view of a vertical blind showing the fabric, panels and vanes.

FIG. 2 is a top view of a portion of a vertical blind.

FIG. 3 is a fragmentary front elevation of a U-type vertical blind in the open position.

FIG. 4 is a fragmentary top view of the U-type vertical blind in the open position.

FIG. 5 is a fragmentary top view of the U-type vertical blind in the closed position.

FIG. 6 is a fragmentary front elevation of the S-type vertical blind in the open position.

FIG. 7 is a fragmentary top view of the S-type vertical blind in the open position.

FIG. 8 is a fragmentary top view of the S-type vertical blind in the closed position.

FIG. 9A is a fragmentary perspective view of a segment of the vertical blind.

FIG. 9B is a fragmentary perspective view of the vertical blind configured as a series of segments.

FIG. 10 is a top view of a portion of a vertical blind formed using adjacently suspended segments to form the U-type vertical blind.

FIG. 11 is a top view of a portion of a vertical blind formed using adjacently suspended segments to form the S-type vertical blind.

FIG. 12 is a fragmentary side elevation cross-sectional view of a pocket panel supported by a hanger.

FIG. 13 is a fragmentary front elevation of a pocket panel showing an alternate embodiment.

FIG. 14 is a front elevation of a vertical blind formed from a combination of segments to form U-type and S-type portions in the same vertical blind.

FIG. 15 is a fabric construction for a vertical blind woven in a width-for-length arrangement.

FIG. 16 is a fabric construction for a vertical blind woven in a width-for-width arrangement.

FIG. 17 is a fabric construction for a vertical blind warp knitted in a width-for-width arrangement.

FIG. 18 is a fabric construction for a vertical blind warp knitted blind warp knitted in a width-for-length arrangement.

### DETAILED DESCRIPTION

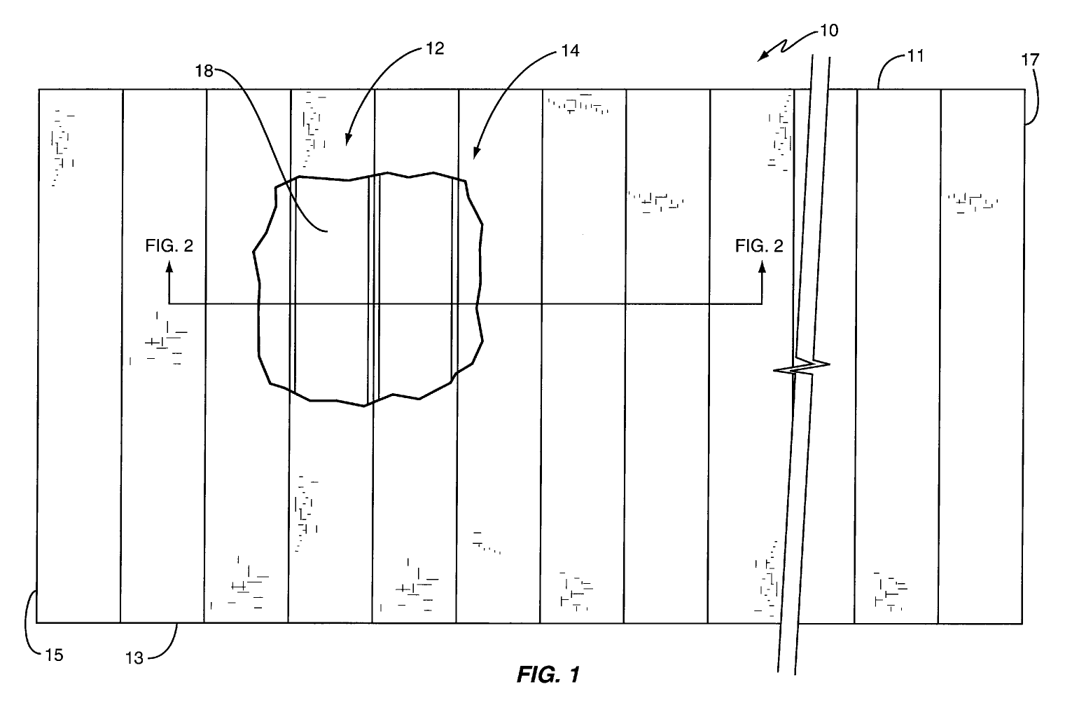

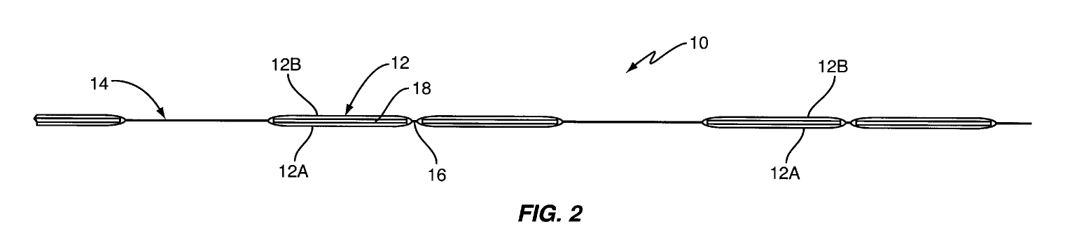

With further reference to the drawings, the present invention provides a vertical blind, indicated generally by the numeral 10. Vertical blind 10 comprises a single fabric sheet extending between side edges 15 and 17 and end edges or portions 11 and 13 and further having a plurality of vertical panels as illustrated in FIG. 1. As used herein, the term “vertical blind” refers to a blind having a plurality of elongated panels that when the blind is hung, extend vertically adjacent an opening, such as a window, in a building. The term “vertical panel” as used herein refers to an elongated portion of a vertical blind that extends generally vertical in the blind when the blind is hung. The vertical panels include pocket panels 12 and panels 14. Panels 12, 14, generally parallel with side edges 15, 17, extend between a top portion 11 and a bottom edge 13. In a preferred embodiment the fabric is a single sheet of fabric with panels 12 and 14 formed in the single fabric sheet. The term “single fabric sheet” or “fabric sheet” means a fabric structure that comes out of a weaving or knitting machine as a single unit. In one embodiment the panels 14 that comprise a part of the vertical blind 10 are non-pocket panels or include a layer of fabric that does not include an opening for receiving a vane or other similar structure. In one embodiment, the fabric includes one panel 14 interposed between two pairs of pocket panels 12. In this embodiment, each pocket panel in a pair is connected to the other pocket panel in the pair by a hinge 16. See FIG. 2.

Forming a part each pocket panel 12 is a vertical pocket. A plurality of vanes 18 is provided and the vanes are contained in pockets. Each vane 18 forms an elongated member that is relatively stiff and substantial as compared to the fabric. Vanes 18 may be comprised of wood, plastic, cardboard, heavy and stiff or starched fabrics, or any other material that forms a relatively stiff elongated member that is capable of moving the pocket panels 12. In cross section, vanes 18 may be flat, ovate, or curved.

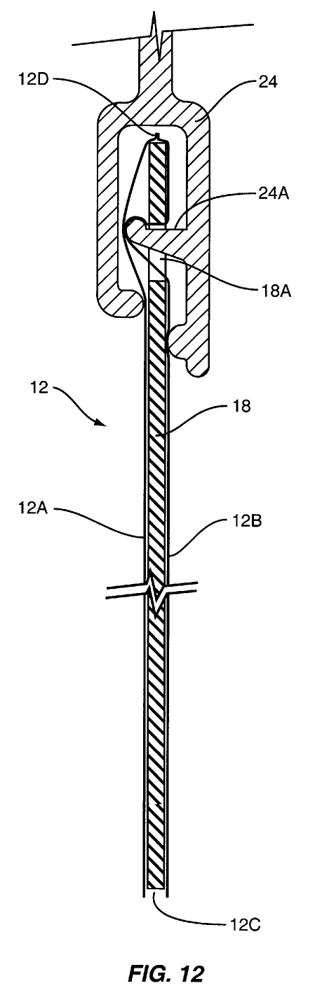

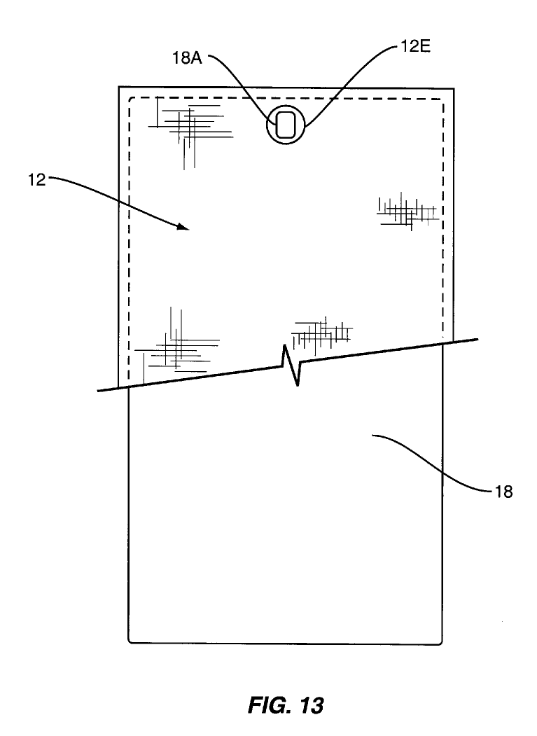

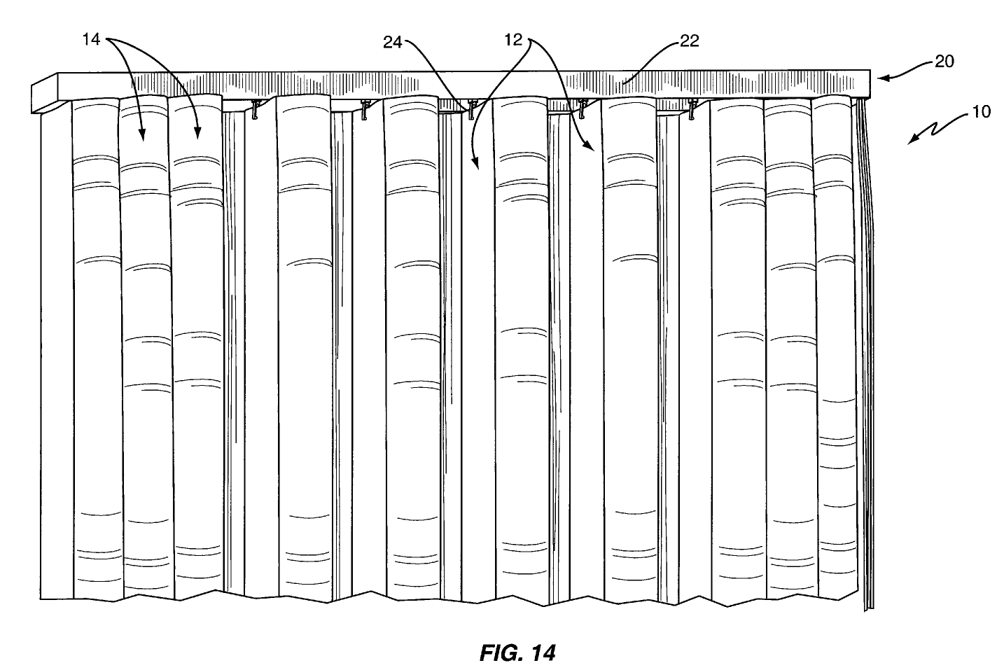

Vertical blind 10 is adapted to be suspended from a support assembly 20. Support assembly is of conventional design, and the details thereof will not be addressed herein. Generally, support assembly 20 includes a frame 22 and a series of moveable hangers 24 as illustrated in FIG. 14. In one embodiment, vanes 18 may include openings 18A for receiving hangers 24 as illustrated in FIGS. 12 and 13.

In one embodiment, the panels of vertical blind 10 may vary in light transmissibility. In one embodiment, panels 14 are designed to be relatively translucent. For example, panels 14 may be of a woven or knitted sheer construction. The other panels, or pocket panels 12, may be relatively opaque. The relative opacity may be provided by the manner of construction of the pocket panels 12 themselves, by the vane 18, or by a combination of the pocket panels and the vanes.

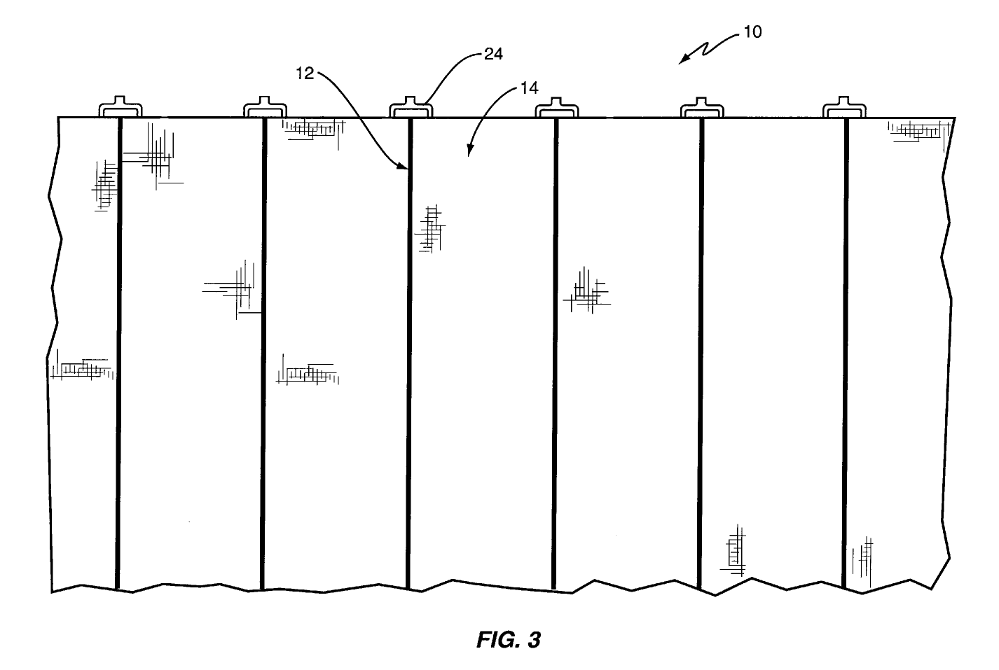

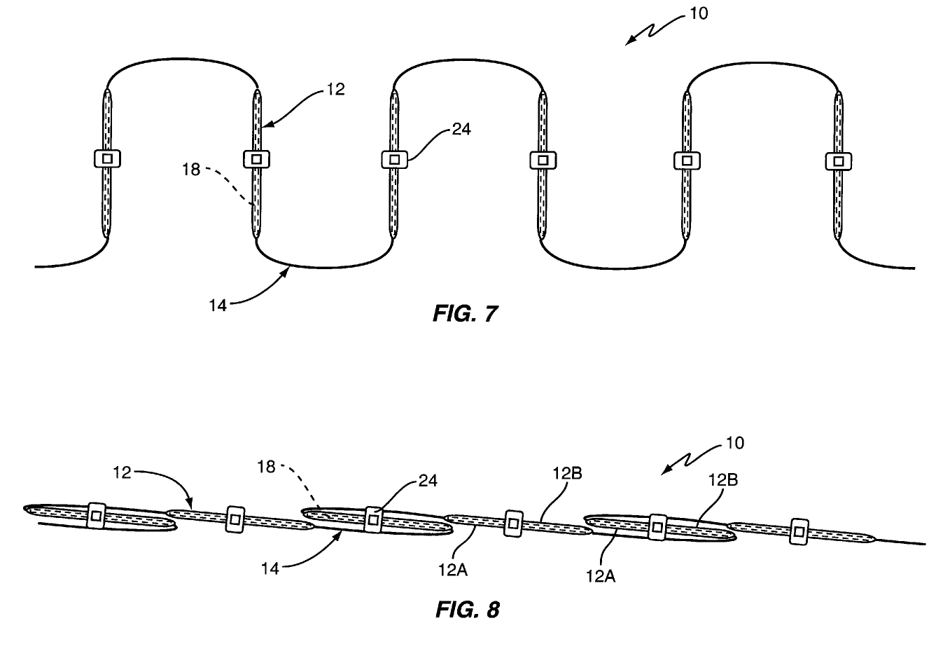

Vertical blind 10 may assume open, closed, and various intermediate positions. For example, when applied to a window in a building, vertical blind 10 may be open to permit some light transmission there through as illustrated in FIGS. 3, 4, 6, and 7. Vertical blind 10 may be closed to generally diminish or prevent light transmission there through. See FIGS. 5 and 8. To provide an intermediate level of light transmission, vertical blind 10 may be positioned in one or more various intermediate positions. Vertical blind 10 can thus be constructed and positioned to provide light transmission into a space, subdued or dimmed light into a space, or substantial darkening of a space.

Generally, in the open configuration or position, the pocket panels 12 are oriented approximately perpendicular to the window surface while panels 14 are oriented somewhat in a parallel fashion to the window. In a closed position, the pocket panels 12 are moved to generally align with and extend along the non-pocket panels 14. In the closed position, pocket panels 12 thus abut or partially overlap adjacent pocket panels across vertical blind 10 to close the blind.

In one embodiment, the panels 12, 14 may have a variety of decorative surface features that display differently depending on the position of vertical blind 10. For example, in an open configuration, panels 14 predominate the front view of vertical blind 10, and any pattern or color of panels 14 is generally fully displayed. In a closed or intermediate position, decorative surface features of the pocket panels 12 will be visible and will provide a different decorative display.

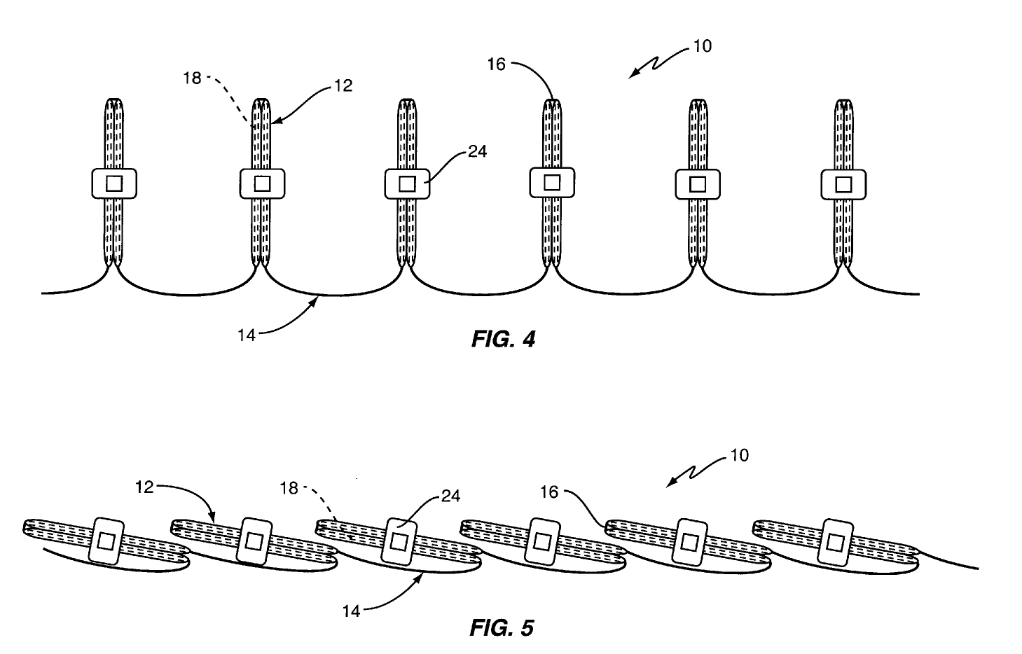

In one embodiment, the fabric comprising vertical blind 10 includes at least two pairs of pocket panels 12 with at least one panel 14 interposed between the two pairs of pocket panels as best illustrated in FIGS. 4 and 5. This embodiment illustrates the U-type of configuration of vertical blind 20. In the open configuration applied to a window, panels 14 are bowed and generally parallel with the window. See FIG. 4. The bowed panels 14 may, in one embodiment, be relatively near the window and bowed towards the window or they may be spaced relatively apart from the window and bowed away from the window. The panels of each pair of pocket panels 12 extend along each other and are generally normal to the window surface such that vertical blind 10 exhibits the form of a series of adjacent “U” shapes. In the closed configuration, illustrated in FIG. 5, the pairs of pocket panels 12 are rotated by turning hangers 24 such that the pocket panels generally extend along panels 14 and abut or slightly overlap adjacent pocket panels.

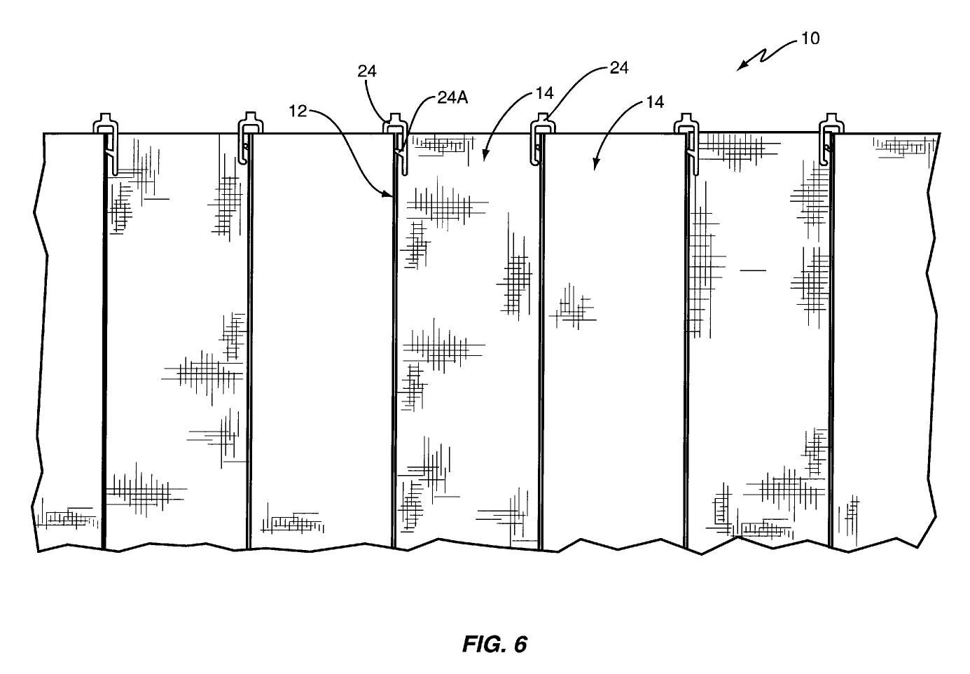

In one embodiment the fabric of vertical blind 10 comprises alternate pocket panels 12 and panels 14 as illustrated in FIGS. 6, 7, and 8. This embodiment illustrates the S-type configuration of vertical blind 10. When suspended adjacent a window, for example, vertical blind 10 in the open configuration has pocket panels 12 oriented generally normal to the window surface, or generally in line with line of sight.

Panels 14 are generally facing the window, with each panel 14 forming a bow. Some panels 14 are thus relatively far from the window while alternate panels are relatively near the window. Vertical blind 10 thus assumes the form of a series “S” shaped portions. Panels 14 may be, in one embodiment, relatively translucent such that substantial light transmission is enabled through vertical blind 10 when in the open configuration. In one embodiment, panel 14 comprises relatively sheer or light-weight construction to enable relative translucence. Additionally, pocket panels 12 may be relatively opaque. In one embodiment, pocket panels 12 comprise relatively dense or heavy-weight construction to enable relative opacity. In the closed configuration, pocket panels 12 are rotated by turning hangers 24 such that the pocket panels generally align with panels 14 with alternate pocket panels being sandwiched between panels 14 as shown in FIG. 8. Pocket panels 12 generally abut or slightly overlap each other to close vertical blind 10.

The fabric of vertical blind 10 may be formed with a varying pattern of pocket panels 12 and panels 14. In one embodiment, a part of the fabric may comprise one or more U-type portions while another part of the fabric may include one or more S-type portions. Various combinations and placements of S-type and U-type portions may be formed in the fabric to provide various appearances. For example, vertical blind 10 may comprise a group of U-type portions forming side borders with a group of S-type portions forming a central section as shown in FIG. 14. Vertical blind 10 may thus be comprised of a single fabric so as to extend continuously over a substantial horizontal width covering, for example, a window or opening in a building.

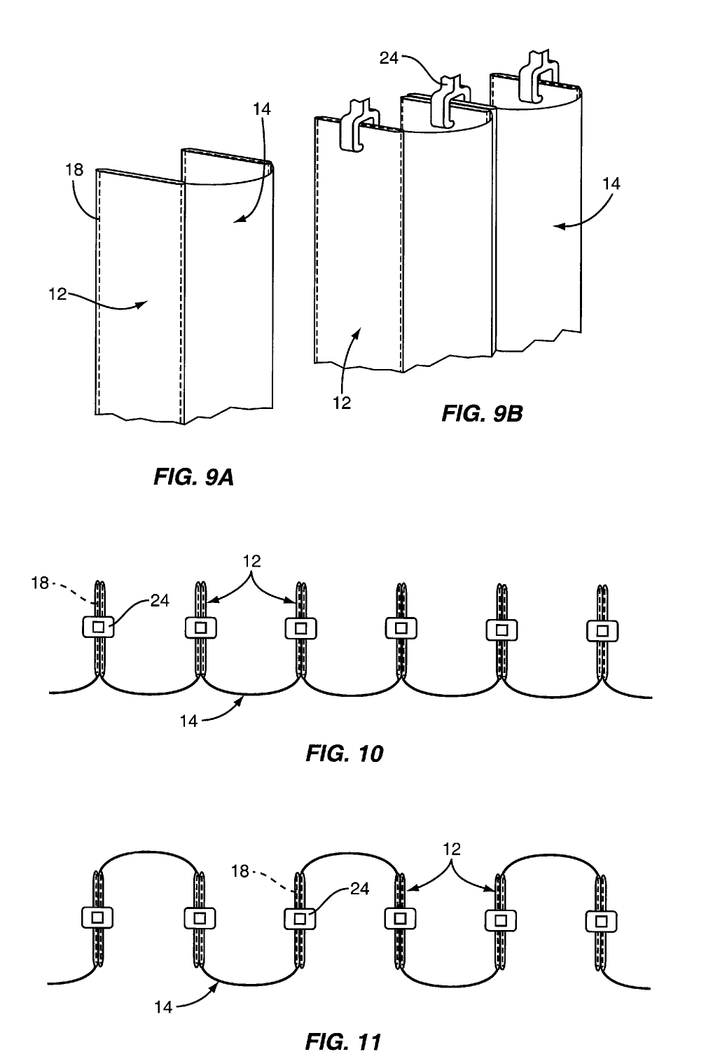

Vertical blind 10 may, in one embodiment, comprise a series of separate segments of fabric. A separate segment may comprise two pocket panels 12 and one panel 14 to form a segment as illustrated in FIG. 9A. Multiple segments may be suspended alongside each other to form a U-type portion of vertical blind 10 as seen in FIG. 9B and further illustrated in FIG. 10. Alternatively, the segments may be juxtaposed in an S-type arrangement as shown in FIG. 11. Thus, various combinations of S-type portions and U-type portions may make up vertical blind 10 by suspending together such segments.

Turning now to a more detailed consideration of the pockets formed by pocket panels 12 of the fabric, each pocket extends along a substantial portion of one of the pocket panels. A pocket is comprised of first and second fabric layers 12A, 12B. Layers 12A, 12B are adjacently disposed, the longitudinal edges thereof being connected together to form the pocket. In one embodiment, a lower end 12C of the pocket is open to permit insertion of vane 18 as illustrated in FIG. 12. In this embodiment, an upper end of the pocket is closed, partially closed, or sealed by connecting together top edges of layers 12A, 12B forming a closure 12D. It is appreciated that pocket panel 12, and thus the fabric of vertical blind 10 is supported by vane 18 when the vane is suspended from hanger 24 as illustrated in FIGS. 13 and 14. It is further appreciated that the support is provided by closure 12D. Closure 12D may be a seam formed by sonic or laser welding, for example, opposed portions of the upper edges of layers 12A, 12B. Closure 12D may be a continuous seam or a series of spaced apart seam segments or other connections between the upper edges of layers 12A and 12B. However configured, closure 12D interacts with vane 18 so that hanger 24 supports the vane 18 and the vane supports the fabric of vertical blind 10 as illustrated in FIG. 12.

Considering now the ways of connecting vertical blind 10 to hangers 24 of support 20, in one embodiment layers 12A and 12B may be continuous over pocket panel 12 as illustrated in FIG. 12. In such cases, the fabric is sufficiently compliant such that stub 24A may distort the fabric and penetrate opening 18A of vane 18. In another embodiment, an opening 12E may be provided in layers 12A, 12B as shown in FIG. 13. Various shapes and ways of making opening 12E may be practiced. Opening 12E may be in the form of a pair aligned holes the upper portion of layers 12A, 12B as illustrated. Alternatively, opening 12E may be a continuous opening extending across the upper ends of layers 12A, 12B and downwardly on both layers. Opening 12E may be formed in the manufacture of the fabric or it may be formed by burning or cutting the manufactured fabric. However formed, opening 12E permits stub 24A to pass through the opening to penetrate opening 18A of vane 18 such that hanger 24 supports the vane.

An alternative way of connecting vertical blind 10 to hangers 24 includes use of an adapter of common design which may be adhered to the upper portion of one or more pocket panels 12. In one embodiment of the U-type configuration, the adapter clips over and is secured to top, or outer, pocket layers 12A of adjacent pocket panels. In one embodiment, the adapter is secured to pocket layers 12a, 12B by adhesion or welding such as by sonic welding. In one embodiment of the S-type configuration, the adapter clips over and is secured to pocket layers 12A, 12B of one of the pocket panels 12. The adapter includes an opening similar to opening 18A in vane 18 for receiving stub 24A of hanger 24. In each of the foregoing embodiments, vanes 18 are supported within the pockets. In one embodiment vanes 18 may be supported by the lower ends of the pockets being at least partially closed. In one embodiment, the adapter compresses the panel or panels over which it clips sufficiently to support the panels by friction. In one embodiment the adapter may include appurtenances to at least partially penetrate the panel or panels to engage and hold the panels such that the ends of the pockets may be open or closed.

Turning now to the manufacture of vertical blind 10, the blind may be formed by various methods forming single sheets of fabric having pocket panels 12 and including non-pocket panels 14. In one embodiment the single fabric sheet is formed by weaving where pocket are integrally formed using techniques known to those of ordinary skill in weaving. In another embodiment a warp-knitted fabric is formed having panels wherein the pockets are integrally knitted into panels of the fabric using techniques known to those of ordinary skill in warp knitting. While yarns of various constituencies may be utilized, it is generally preferred to use low melting point synthetic yarns in weaving or warp knitting the single fabric sheet to enable subsequent heat setting of the single fabric sheet, as will be further discussed here below.

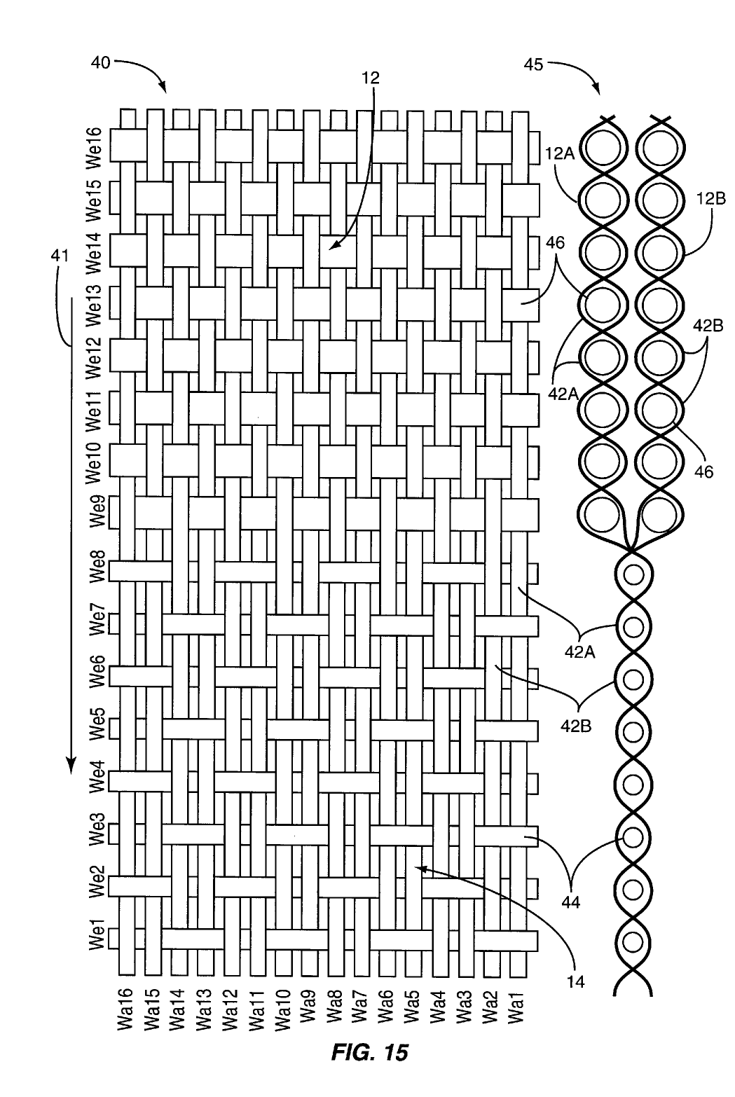

In one embodiment, vertical blind 10 may be manufactured by weaving a single fabric sheet in a width-for-length arrangement on a loom. See FIG. 15. In this embodiment, the single fabric sheet is formed in the loom such that vertical dimension of vertical blind 10 is oriented across the operating width of the loom. The panels 12, 14 are sequentially formed in the weaving process. Top portion 11 and bottom portion 13 of vertical blind 10 (see FIG. 1) thus extend longitudinally from the loom as the single fabric sheet is woven and are longitudinally aligned with the general direction of movement of the fabric through the loom. In this embodiment the length of vertical blind 10 is limited by the operating width of the loom.

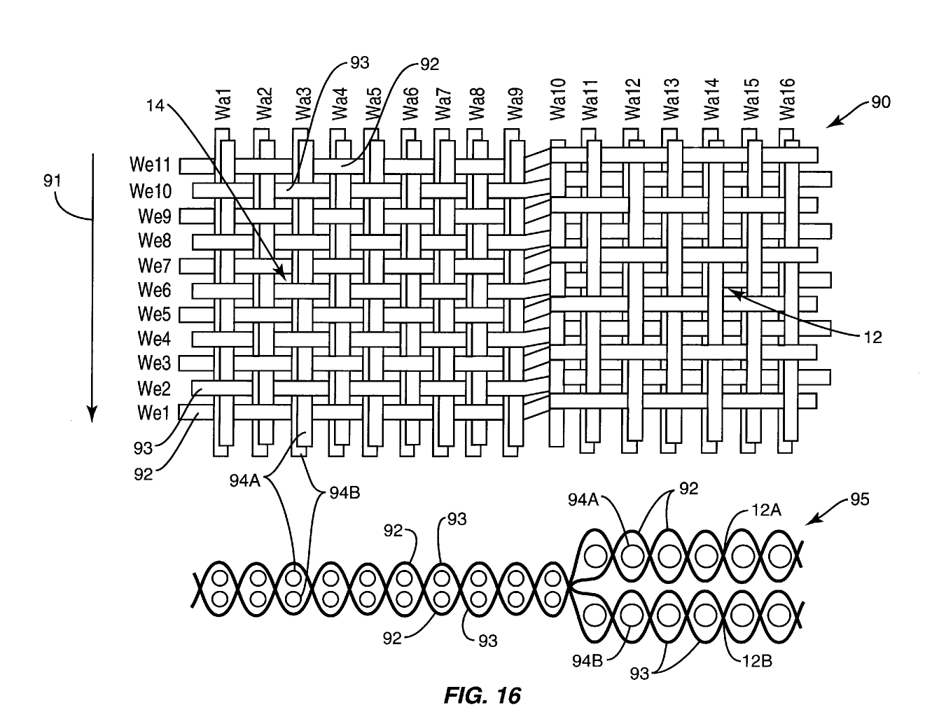

In another embodiment, vertical blind 10 may be manufactured by weaving a single fabric sheet in a width-for-width arrangement on a loom. See FIG. 16. In this embodiment the single fabric sheet is formed in the loom such that the vertical dimension of vertical blind 10 is oriented generally perpendicular to the operating width of the loom. Panels 12, 14 are generally simultaneously formed by the weaving process. Side edges 15, 17 (see FIG. 1) of vertical blind 10 thus extend longitudinally from the loom, generally perpendicular to the operating width of the loom and are aligned longitudinally with the general direction of movement of the single fabric sheet through the loom. In this embodiment the length of vertical blind 10 is not limited by the operating width of the loom.

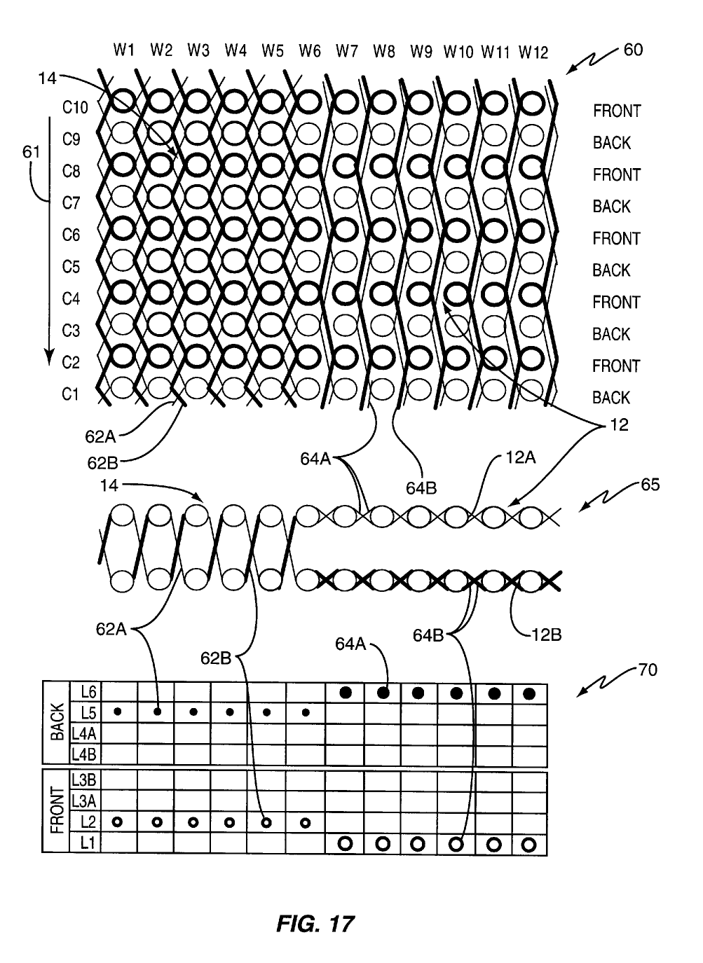

In another embodiment vertical blind 10 may be manufactured by warp knitting a single fabric sheet in a width-for-width arrangement on a knitting machine. See FIG. 17. In this embodiment the single fabric sheet is formed in the knitting machine such that the vertical dimension of vertical blind 10 is oriented generally perpendicular to the operating width of the knitting machine. Panels 12, 14 are generally simultaneously formed by the warp knitting process. Side edges 15, 17 (see FIG. 1) of vertical blind 10 thus extend longitudinally from the knitting machine, generally perpendicular to the operating width of the knitting machine and aligned longitudinally with the general direction of movement of the single fabric sheet through the knitting machine. In this embodiment the length of vertical blind 10 is not limited by the operating width of the loom.

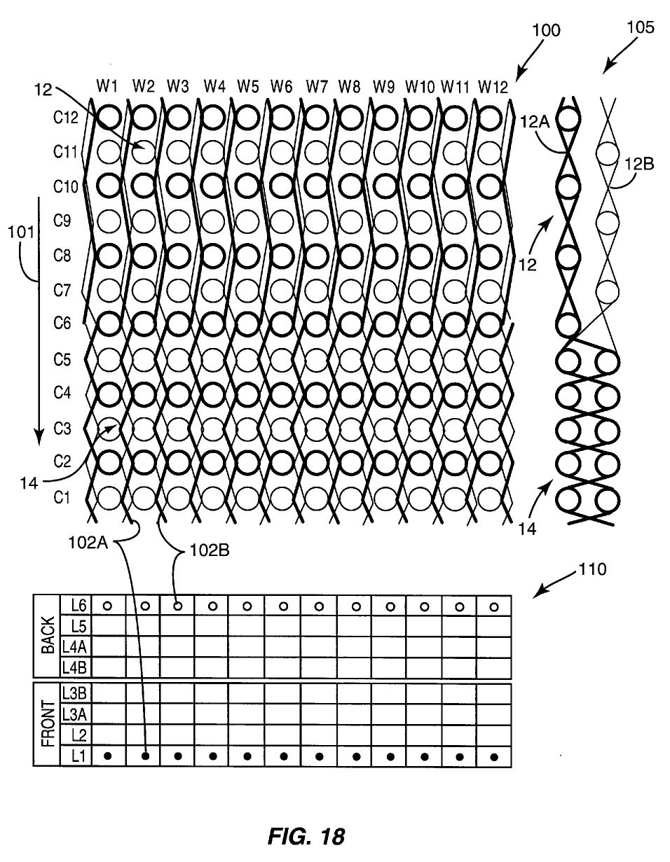

In another embodiment, vertical blind 10 may be manufactured by warp knitting a single fabric sheet in a width-for-length arrangement on a knitting machine. See FIG. 18. In this embodiment, the single fabric sheet is formed in the knitting machine such that vertical dimension of vertical blind 10 is oriented across the operating width of the knitting machine. Panels 12, 14 are sequentially formed in the warp knitting process. Top portion 11 and bottom portion 13 of vertical blind 10 (see FIG. 1) thus extend longitudinally from the knitting machine as the single fabric sheet is knitted and are longitudinally aligned with the general direction of movement of the fabric through the knitting. In this embodiment the length of vertical blind 10 is limited by the operating width of the knitting machine.

It is appreciated that the panels may be formed in any desired sequence to produce vertical blind 10 with S-type, U-type, or combination features. It is sufficient to describe the formation of one panel 14 followed by an adjacent pocket panel 12.

FIG. 15 illustrates the structure of a portion of the fabric for vertical blind 10 as woven in a width-for-length arrangement on a Jacquard Loom. Reference 40 generally indicates the construction of the fabric, showing sixteen warps Wa1-Wa16 and sixteen wefts We1-We16 of the fabric. Direction arrow 41 indicates the direction in which the fabric moves through the loom as it is woven. Fabric cross section 45 illustrates a side view of the fabric. The fabric portion shown comprises a part of one of the panels 14 alongside a part of one of the pocket panels 12 formed by two layers 12A and 12B. For purposes of reference, panel 14 is referred to as a non-pocket panel. The non-pocket portion shown extends over wefts We1 to We8 and the pocket portion shown extends over wefts We9 to We16. The fabric is formed using a warp yarns 42A, 42B and first and second weft yarns 44, 46. Second weft yarn 46 is sometimes referred to as the pocket yarn. Warp yarns 42A, 42B are warped in pairs, two up-two down to form non-pocket panel 14. For example, warp yarns 42A, 42B in warps Wa3, Wa4 pass side-by side over first weft yarn 44 in weft We1, under yarn 44 in weft We2, over yarn 44 in weft We3, and so on until weft We9 to form part of non-pocket panel 14. Thence, warp yarn 42A passes over pocket yarn 46 in weft We9, under pocket yarn 46 in weft We10, over pocket yarn 46 in weft We 11 and so on. Likewise, warp yarn 42A in warp Wa5 passes under and over pocket yarns 46 in wefts We9 and following wefts in opposition to the yarn in warp Wa3 to form one layer 12A of the pocket as shown in side view 45 of FIG. 15. After weft We8, warp yarn 42B interacts similarly with pocket yarns 46 to form layer 12B of the pocket.

In one embodiment, where non-pocket panel 14 is a relatively translucent, sheer, or light-weight panel and pocket panel 12 is a relatively opaque or heavy-weight panel. First weft yarn 44 may be substantially smaller and lighter than the second weft or pocket yarn 46. Warp yarns 42A, 42B are generally identical to each other and, of course, continuous across all panels. A typical yarn selection for one embodiment is presented in Table I.

TABLE I

| Warp Yarns 40A, 40B | 2 ends 20 denier monofilament poly full dull |
|---|---|
| | 14.5 turns Z |
| First Weft Yarn 42 | 3 ends 15 denier monofilament bright trilobal |
| | poly 10 turns Z. |
| Second Weft (Pocket) Yarn | 1 end 400 denier spun yarn |
| 44 | |

The length of the panels, and thus of vertical blind 10, is determined for the particular application. This length, however, may be limited by the width of the weaving machine when the fabric is woven in a width-for-length arrangement as described here above. Typical maximum length is about 118 inches (300 cm). The width of the panels may likewise be variable. However, an exemplary panel width is about 4 inches (10.2 cm). In the case of pocket panels 12, the inside width of the pocket is generally about 3.75 inches (9.5 cm) to accommodate vanes 18 having a width of about 3.5 inches (8.9 cm). Where hinges 16 are required, as between adjacent pocket panels 12 in one embodiment of the U-type configuration, the hinges are typically about 3/16 inches (0.5 cm) wide and formed similarly to non-pocket panels 14. It is appreciated that alternative lengths and widths may be employed for various applications. Where the fabric is to be cut into separate segments, for example including two pocket panels 12 and one panel 14, a transition portion may be woven connecting the panels 12 and 14. This transition portion may include a narrow strip running longitudinally alongside the pocket where a heavier first warp yarn 44 may be used. This transition portion is generally about ⅛ inch (0.3 cm) wide and may serve as a cutting guide for cutting the segments from the fabric.

As noted here before, vertical blind 10 may be formed by weaving a single fabric sheet in a width-for-width arrangement as illustrated in FIG. 16. Reference 90 generally indicates the construction of the single fabric sheet, showing a portion including sixteen warps Wa1-Wa16 and eleven wefts We1-We11 of the single fabric sheet. Direction arrow 91 indicates the direction in which the fabric moves through the loom as it is woven. Reference numeral 95 illustrates an end view of the fabric viewed as it moves from the loom. The portion of the single fabric sheet shown comprises a part of one of panel 14 alongside a part of one of the pocket panels 12 formed by layers 12A, 12B. Non-pocket panel 14 shown extends over warps Wa1 to Wa9, and pocket panel 12 extends over warps Wa10 to Wa16.

The single fabric sheet is formed using first and second warp yarns 94A, 94B and weft yarns 92, 93. Warp yarns 94A, 94B are warped in a shed two up-two down in overlapping pairs to form non-pocket panel 14 with weft yarns 92, 93 shuttled alternately within the shed. For example, warp yarns 94A, 94B warp above and below paired weft yarns 92, 93 in panel 14. In the example construction shown, beginning with warp Wa11, weft yarns 92 cooperate with warp yarns 94A to weave layer 12A of pocket panel 12, and weft yarns 93 cooperate with warp yarns 94B to weave layer 12B of the pocket panel. In one embodiment, non-pocket panel 14 is formed from 40-45 denier yarns in the warp and the weft to form, for example, a sheer non-pocket panel 14. In one embodiment, pocket panel 12 is formed from 40-45 denier yarns in the weft and approximately 400 denier yarns in the warp to form relatively opaque or heavy upper and lower layers 12A and 12B.

It is appreciated that layers 12A and 12B may be of the same or of different colors. For example, in one embodiment yarns 94A and 92 may be white in color while yarns 94B and 93 may be of a darker color or shade such that pocket panel 12 has a white side 12A and a darker or colored side 12B.

Yarn consumption rate may differ for non-pocket panels 14 and pocket panels 12. Thus dynamic tensioning or dual warp beams may be used to control yarn consumption into non-pocket panels 14 and pocket panels 12.

As here before noted, when woven in a width-for-width arrangement here described, the length of finished panels is not limited by the width of the loom as is the case with the width-for-length arrangement described here before. Also, functional fabrics for vertical blind 10 may be woven width-for-width on narrower looms, 150 cm for example, than can those woven in the width-for-length arrangement. Moreover, such fabrics for vertical blind 10 may be formed in a width-for-width arrangement on a course gauge loom than is the case for the width-for-length arrangement.

Vertical blind 10 may also be formed by warp knitting a single fabric sheet on a Double Needle Bar Raschel Machine with a Piezo-Jacquard System such as the Nippon Mayer RDPJ 6/2. In one embodiment, noted here before, vertical blind 10 may be knitted in a width-for-width arrangement. In this embodiment panels 12, 14 are generally arrayed in perpendicular fashion across the width of the machine, and the panels can be any length. In another embodiment, also noted here before, vertical blind 10 may be knitted in a width-for-length arrangement wherein panels 12, 14 are arrayed generally parallel to the width of the knitting machine and thus are limited in length by the width of the knitting machine.

The warp knit construction, in the width-for-width arrangement, of the single fabric sheet for vertical blind 10 is illustrated in FIG. 16. A construction diagram 60 indicates the series of instantaneous needle locations and stitching to form the fabric, illustrating a portion of the fabric defined by courses C1-C10 and wales W1-W13. Arrow 61 indicates the direction of movement of the fabric through the knitting machine as it is formed. A portion of one of the panels 14 is shown alongside a portion of one of the pocket panels 12. An end view 65 of the fabric shows a portion of panel 14 along with a portion of a pocket formed between layers 12A, 12B. A threading diagram 70 shows guide bars for front and back needle bars of the RDPJ 6/2 labeled respectively “FRONT” and “BACK”. The single fabric sheet is knitted utilizing a first group of yarns 62A, 62B fully threaded in guide bars L2 and L5 to form panels 14. A second group of yarns 64A, 64B, sometimes called pocket yarns, is fully threaded in guide bar L1 and L6 to form pocket panels 12. In one embodiment, yarns 64A, 64B are heavier, or of a higher denier, than yarns 62A, 62B. The fabric is formed using closed tricot stitches in a manner known to those of ordinary skill in warp knitting.

Generally, to form panel 14, yarns 62A, 62B form closed tricot stitches that run up course from one course to the next connecting adjacent wales. It is appreciated that the double needle bar of the RDPJ 6/2 can produce a single fabric sheet that encompasses two parallel planes, a back plane associated with the back needle bar and the front plane associated with the front needle bar. However, the needles may deflect to tie stitches between planes in panel 14 as illustrated in the left hand portion of end view 65 in FIG. 17. More particularly, for example, yarn 62A executes a closed tricot stitch at course C1-wale W3 in the back plane. Yarn 62A then laps to from a closed tricot stitch at course C2—wale W2 in the front plane, and so forth. Yarn 62B executes a closed tricot stitch at course C1-wale W2 in the back plane and laps to course C2-wale W3 in the front plane and so forth. The yarns thus alternate from wale to adjacent wale and from back plane to front plane to form panels 14 as illustrated in side view 70.

To form pocket panels 12, the yarns do not alternate between planes. Rather, yarns 64A form layer 12A in the back plane by closed tricot stitches connecting adjacent wales, and yarns 64B form layer 12B in the front plane similarly by making close tricot stitches connecting adjacent wales. For example, yarn 64A executes a closed tricot stitch at course C1-wale W8 in the back plane and, remaining in the back plane makes a tricot stitch at course C3-wale W7 to form layer 12A. Yarn 64B, for example, forms a closed tricot stitch at course C2-wale W9 in the front plane and, remaining in the front plane makes a tricot stitch to course C4-wale W8, and so forth. In this manner layers 12A and 12B of the pocket are formed as illustrated in side view 70.

Yarns of the first group 62A, 62B may be identical to yarns of the second group 64A, 64B. As has been noted, however, the two groups of yarns may differ. For example, when it is desired to provide a relatively sheer or light-weight panel 14 and a relatively heavy-weight pocket panel 12 yarns 64A, 64B may be heavier yarns than yarns 62A, 62B.

It is appreciated that layers 12A and 12B in the width-for-width warp knitted embodiment may be of the same or of different colors. For example, in one embodiment yarns 64A may be white in color while yarns 64B may be of a darker color or shade such that pocket panel 12 has a white side 12A and a darker or colored side 12B.

A typical yarn selection for one embodiment of vertical blind 10 is given in Table II below.

TABLE II

| | |
|---|---|
| Yarns 62A, 62B | 2 ends 20 denier monofilament poly full dull |
| | 14.5 turns Z |
| Yarns 64A, 64B | 1 end 70 denier 34 filament tex. yarn |
| (pocket yarns) | |

As noted here before, it is possible to warp knit the single fabric sheet for vertical blind 10 using a width-for-length arrangement as illustrated in FIG. 18. A construction diagram 100 illustrates a portion of the fabric defined by courses C1-C12 and wales W1-W12. Arrow 101 indicates the direction of movement of the fabric through the knitting machine as it is formed. A portion of one of the panels 14 is shown alongside a portion of one of the pocket panels 12. A side view 105 of the fabric shows a portion of panel 14 along with a portion of a pocket formed between layers 12A, 12B. A threading diagram 110 shows guide bars for front and back needle bars of the RDPJ 6/2 labeled respectively “FRONT” and “BACK”. The single fabric sheet is warp knitted utilizing a first group of yarns 102A and a second group of yarns 102B fully threaded in guide bars L1 and L6 to form the fabric for blind 10. The fabric is formed using closed tricot stitches in a manner known to those of ordinary skill in warp knitting.

Generally, to form panel 14, yarns 102A, 102B form closed tricot stitches that run up course from one course to the next connecting adjacent wales. As discussed here before, the double needle bar of the RDPJ 6/2 can produce a single fabric sheet that encompasses two parallel planes, a back plane associated with the back needle bar and the front plane associated with the front needle bar. However, the needles may deflect to tie stitches between planes as illustrated in the lower portion of side view 105 in FIG. 18. More particularly, for example, yarn 102A executes a closed tricot stitch at course C1-wale W2 in the back plane. Yarn 102A then laps to from a closed tricot stitch at course C2—wale W2 in the front plane, and so forth. Yarn 102B executes, for example, a closed tricot stitch at course C1-wale W3 in the back plane and laps to course C2-wale W2 in the front plane and so forth. The yarns thus alternate from wale to adjacent wale and from back plane to front plane to form panels 14 as illustrated in side view 105.

To form pocket panels 12, the yarns do not alternate between planes. Rather, yarns 102A form layer 12A in the back plane by closed tricot stitches connecting adjacent wales, and yarns 102B form layer 12B in the front plane similarly by making close tricot stitches connecting adjacent wales. For example, yarn 102A executes a closed tricot stitch at course C6-wale W2 in the front plane and, remaining in the front plane makes a tricot stitch at course C8-wale W1 to form layer 12A. Yarn 102B, for example, forms a closed tricot stitch at course C6-wale W3 in the back plane and, remaining in the back plane makes a tricot stitch to course C8-wale W2, and so forth to form layer 12B. In this manner layers 12A and 12B of the pocket are formed as illustrated in side view 105. Yarn consumption rate is greater when non-pocket panels 14 are being formed that when pocket panels 12 are being formed. Thus dynamic tensioning may be used to control yarn flow as warp knitting moves alternatingly along from forming non-pocket panels 14 to pocket panels.

Yarns of the first group 102A may be identical to yarns of the second group 102B. The two groups of yarns may differ as well. Generally, heavier yarns are included in group 102A when it is desired to have layer 12A of the pocket 12 heavier than layer 12B. It is appreciated, however, that the use of heavier yarns 102A will also result in a heavier structure of non-pocket panel 14.

As is the case with a woven vertical blind 10, the length of the warp knitted panels is determined for the particular application. However, in the case of vertical blind 10 warp knitted in a width-for-width arrangement the length has no practical limit as noted here before. In the case of the blind warp knitted in a width-for-length arrangement, the length of panels 12, 14 is limited by the width of the knitting machine.

To provide structural substance to panel 14, for example when the panel is of a sheer or light-weight construction, the fabric may be heat set to at least partially fuse warp and weft yarns on the loom as the single fabric sheet is formed. This fusing by heat setting stabilizes the single fabric sheet and adds to the ability of the single fabric sheet to maintain shape. Maintaining shape assists in forming and holding a bow in sheer non-pocket panels 14 when vertical blind 10 is not closed.

Where required, and whether formed by weaving, knitting, or other fabrication method, ends of pockets are closed to form closure 12D. Further, depending on the method of manufacture, selvages may be formed and required to be cut off. Also, in forming segments which can be assembled into blinds as described here before, the single fabric sheet material is required to be precisely cut. Generally, using heat provided in various forms provides the sealing and cutting functions. For example a sonic cutter or laser cutter may be used to cut the single fabric sheet. Such cutters function by passing a cutter head along the fabric at a pre-determined speed. Synthetic yarns are preferred for such cutting. Energy from the cutter melts the fabric, generally severing the fabric. Where cutting is across pockets, the speed of the cutter can be adjusted such that layers 12A, 12B are cut clean leaving edges without fusing the layers together. However, in the case of sealing or closing the end of a pocket, the speed of the cutter may be modified, generally to a relatively lower speed, in order to transfer more heat energy to melt and fuse end portions of layers 12A, 12B. The remaining selvage may be cleanly torn away leaving a closure 12D closing the end of the pocket.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A method of manufacturing a vertical blind comprising:
a. weaving a single fabric sheet on a loom and forming within the single fabric sheet a series of elongated panels such that as the single fabric sheet is woven and generally moves in a direction away from the loom, the elongated panels are oriented in the same direction and extend in the general direction of movement of the single fabric sheet as the single fabric sheet moves with respect to the loom;
b. forming at least one panel of the series of panels as a relatively translucent panel;
c. forming at least two panels of the series of panels as pocket panels, wherein each pocket panel includes a pocket configured to receive and hold a vane; and
d. wherein the woven single fabric sheet having the relatively translucent panels and pocket panels forms the vertical blind.

2. The method of claim 1 wherein as the single fabric sheet is woven the single fabric sheet includes a pair of side edges, a top portion disposed adjacent the loom, and a bottom edge disposed opposite the top portion; and wherein the method includes weaving the single fabric sheet such that as the pockets are woven, the pockets extend generally parallel to the side edges of the single fabric sheet and from the top portion to the bottom edge.

3. The method of claim 1 including providing a series of vanes for insertion into the pockets of the vertical blind.

4. The method of claim 3 wherein when one of the vanes is inserted into one of the pockets, the pocket panel and vane form a relatively opaque panel.

5. The method of claim 1 including closing an end of a pocket by fusing edges of fabric layers of the pocket together, and leaving open an opposite end portion of the pocket such that a vane can be inserted into the pocket through the open end portion.

6. The method of claim 5 wherein closing an end of a pocket includes cutting the fabric layers with a sonic cutter or a laser cutter at a relatively slow speed such that energy transmitted from the sonic or laser cutter melts a portion of the fabric layers fusing portions of the fabric layers together.

7. The method of claim 5 wherein leaving open an opposite end portion of the pocket includes cutting the fabric layers with a sonic cutter or a laser cutter at a relatively high speed such that energy transmitted from the sonic or laser cutter melts a portion of the fabric layers without fusing the fabric layers together.

8. The method of claim 1 wherein the vertical blind includes a top portion and a bottom portion, and wherein the method includes closing a first end of the pocket about a top portion of the vertical blind while leaving open a second end of the pocket about the bottom portion of the vertical blind.

9. The method of claim 8 wherein closing the first end of the pocket includes cutting the single fabric sheet by performing a relatively slow cutting action across the top portion wherein the relatively slow cutting action closes the first end of the pocket and performing a relatively fast cutting action across the bottom portion wherein the relatively fast cutting action leaves the second end of the pocket open.

10. The method of claim 9 wherein cutting the single fabric sheet includes providing energy to the single fabric sheet utilizing a sonic cutter or a laser cutter.

11. The method of claim 1 including forming at least one of the pocket panels by weaving a front layer having one color or shade and a back layer having another color or shade.

12. The method of claim 1 including forming at least one of the pocket panels by weaving together yarns of a first color or shade to form a front layer of the pocket panel and by weaving together yarns of a white color to form a back layer of the pocket panel.

13. A method of manufacturing a vertical blind comprising:
a. weaving a single fabric sheet on a loom and forming within the single fabric sheet a series of elongated panels such that as the single fabric sheet is woven and moves in a first direction away from the loom, the elongated panels are oriented in a second direction that is perpendicular to the first direction;
b. forming at least one panel of the series of panels as a relatively translucent panel;
c. forming at least two panels of the series of elongated panels as pocket panels, wherein each pocket panel includes a pocket for receiving a vane; and
d. wherein the woven single fabric sheet having the relatively translucent panels and pocket panels forms the vertical blind.

14. The method of claim 13 including providing at least two vanes, each vane being insertable into one of the pockets such that the pocket can be moved by moving the vane; and wherein the pocket and the vane, when inserted into the pocket form a relatively opaque panel.

15. The method of claim 13 including closing a first end of a pocket panel by cutting opposed fabric layers at a relatively low speed with a sonic or laser cutter and fusing portions of the fabric layers together; and leaving open a second end of the pocket by cutting opposed fabric layers at a relatively high speed with a sonic or laser cutter.

16. A method of manufacturing a vertical blind comprising:
a. knitting a single fabric sheet on a knitting machine and forming within the single fabric sheet a series of elongated panels such that as the single fabric sheet is knitted and moves in a first direction away from the knitting machine, the elongated panels are oriented in a second direction that is perpendicular to the first direction;
b. forming at least one panel of the series of panels as a relatively translucent panel;
c. forming at least two panels of the series of panels as pocket panels, wherein each pocket panel includes a pocket for receiving a vane; and
d. wherein the knitted single fabric sheet having the relatively translucent panels and pocket panels forms the vertical blind.

17. The method of claim 16 including providing at least two vanes, each vane being insertable into one of the pockets such that the pocket can be moved by moving the vane; and wherein the pocket and the vane, when inserted into the pocket, form a relatively opaque panel.

18. The method of claim 16 including closing a first end of a pocket panel by cutting opposed fabric layers at a relatively low speed with a sonic or laser cutter and fusing portions of the fabric layers together; and leaving open a second end of the pocket by cutting opposed fabric layers at a relatively high speed with a sonic or laser cutter.

19. A method of manufacturing a vertical blind comprising:
a. knitting a single fabric sheet on a knitting machine and forming within the single fabric sheet a series of elongated panels such that as the single fabric sheet is knitted and moves in a direction away from the knitting machine, the elongated panels are oriented in the same direction;
b. forming at least one panel of the series of panels as a relatively translucent panel;
c. forming at least two panels of the series of panels as pocket panels, wherein each pocket panel includes a pocket for receiving a vane; and
d. wherein the knitted single fabric sheet having the relatively translucent panels and pocket panels forms the vertical blind.

20. The method of claim 19 including providing at least two vanes, each vane being insertable into one of the pockets such that the pocket can be moved by moving the vane; and herein the pocket and the vane form a relatively opaque panel.

21. The method of claim 19 including closing a first end of a pocket panel by cutting opposed fabric layers at a relatively low speed with a sonic or laser cutter and fusing portions of the fabric layers together; and leaving open a second end of the pocket by cutting opposed fabric layers at a relatively high speed with a sonic or laser cutter.

22. The method of claim 19 including forming at least one of the pocket panels by knitting a front layer having one color or shade and a back layer having another color or shade.

23. The method of claim 1 including forming at least one of the pocket panels by weaving together yarns of a first color or shade to form a front layer of the pocket panel and by weaving together yarns of a white color to form a back layer of the pocket panel.
